(19) United States
(12) Patent Application Publication
(10) Pub. No.: US 2006/0143958 A1
(43) Pub. Date: Jul. 6, 2006

(54) Display surface

(76) Inventor: Marc Jurgen Gerrits, Auckland (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/536,171

(22) PCT Filed: Nov. 19, 2003
(86) PCT No.: PCT/NZ03/00255

§ 371 Date: Jan. 3, 2006

(30) Foreign Application Priority Data
Nov. 19, 2002 (NZ) 522684

(51) Int. Cl. G09F 21/04; G09F 17/00

(52) U.S. Cl. 40/591; 40/603

(57) ABSTRACT

This invention relates to a display layer adapted to be attached to a vehicle wherein the display layer is adapted to be secured to a support layer via at least one affixing means, and wherein the display layer is formed from at least one sheet of flexible material which in use is placed under tension in at least one direction. In preferred embodiments, in order to place the display layer under tension, the display layer is shaped with at least one side being inwardly contoured, and as such, the central portion of the display layer is placed under greater tension than the edges. Furthermore, the edges of at least the display layer may be configured to provide an anchor element that can be secured in an affixing means to provide the required tension.

### TECHNICAL FIELD

This invention relates to an improved display surface or layer.

In particular it relates to an improved display surface or layer for vehicles with sidings that can be used for displaying advertising media or the like, although this should not be seen to be limiting, as it should be appreciated that this could also apply to building advertising also.

### BACKGROUND ART

Many vehicles are used as mediums to present advertising to the public. A large proportion of soft-sided trucks, being trucks with reinforced canvas or fabric sidings, are used to exhibit advertising campaigns. The canvas or fabric can be printed to a high level of definition, presenting quality graphics that are both eye-catching and constantly on the move. The printing does not limit the ability of the canvas to be pulled to one side or the other like a curtain to allow access to the load.

It is an advantage of this type of advertising medium that it reaches people in other vehicles on the road, those looking out of windows, albeit home or office, and those on foot.

It is a disadvantage of this type of advertising medium however that it is expensive to prepare. Accordingly, the majority of campaigns promoted on this type of medium are long-term. Long-term campaigns do not normally make up the majority of advertising platforms currently in use.

The public are usually barraged with a highly visible, constantly changing advertising message. In particular, a large number of campaigns have many facets, therefore requiring the advertising message to be updated frequently. This is particularly noticeable for story type advertising, where every few months a new portion of the story is told, thereby holding people's interest.

A truck siding is therefore not ideal as a cost effective advertising medium for that type of campaign.

In order to have a truck siding prepared for an advertising campaign, a layer, usually canvas or polyvinyl chloride (PVC), must be printed up. If the campaign is a particularly long one, the canvas can be clear coated. While the clear coating extends the life of the siding, it also adds to the already significant the cost of production. The canvas to be used for the siding must be reinforced with a weighted webbing or the like in order to both provide strength to the siding, and ensure that any load within the truck is held inside if it should become unsecured during transit.

Additionally, each reinforced printed canvas is of a specific shape to fit a type of trailer. Usually, that truck alone can only be used to carry the canvas, as it would increase the costs again to have the canvas refitted to another truck siding. As such, not only is it expensive to produce a canvas advertisement, that advertisement can only be carried, usually, on the truck it was initially fitted to. This is a disadvantage as the owner/driver may wish to carry a competitor's product at a later date, or the campaign may have become outdated and the truck then also appears older.

It would be an advantage to be able to produce a cheaper way of presenting advertising on vehicle sidings. By bringing the price associated with that type of advertising medium down, truck siding advertising would become more accessible to other types of campaigns, including short-term campaigns.

It should also be appreciated that other advertising forms use printed reinforced fabric as well. The large canvases produced to cover sides of buildings are also expensive to produce and must be reinforced to withstand variable weather conditions.

It would be an advantage to be able to reduce the costs associated with this type of advertising medium as well.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a display layer adapted to be attached to a vehicle

wherein the display layer is adapted to be secured to a support layer via at least affixing means, and

wherein the display layer is formed from at least one sheet of flexible material

which, in use is placed under tension in at least one direction.

The term ‘display layer’ in accordance with the present invention should be understood to mean a layer on which a display can be presented.

In some embodiments this display layer may be made of a material such as canvas or polyvinyl chloride (PVC) that is able to receive print ink to produce a display of a desired quality, although these are listed by way of example only and should not be seen to be limiting in any way, as the material could also be silk or nylon or the like.

In preferred embodiments the display layer material may be PVC of a desired weighting usually around 470 gsm (gram per square metre) and extending up to approximately 600 gsm, although again this is listed by way of example and should not be seen to be limiting. It should be appreciated that various weightings outside the above listed range, such as between 400 and 700 gsm may be suitable for other purposes such as smaller indoor displays or the like.

It should further be appreciated that the PVC can be coated with a clear protective coating to lengthen the lifetime of the printed image, by reducing its exposure to the elements such as rain, road grime and high winds, scratching and UV light.

All materials or fabrics have a certain amount of ‘give’ or flexibility. This allows them to be placed under tension and deformed slightly. Some materials will deform more than others, the greater the deformation, the more tension required to pull the material taut. By forming the display layer out of a slightly flexible material such as PVC, the material can be tensioned to present a suitably taut or firm layer.

By applying tension in at least one direction, the display lay may be held sufficiently rigid so that it will not flap when exposed to high winds or the like. When a vehicle is travelling at speed, turbulence causes most materials to flap or flutter. This flapping can lead to tearing, or in the case of a vehicle siding, the degradation of any image printed on it. Flapping may also mean that the image displayed is not clearly visible to an onlooker.

It is therefore an advantage to be able to tension any material in order to lessen any movement. Additionally, significant levels of flapping of sidings or covers are considered unsafe by the road safety authority and are therefore regulated against by the Authorities.

According to another aspect of the present invention there is provided a display layer to be attached to a vehicle as described above

Wherein the display layer is shaped with at least one portion of the display layer side being inwardly contoured.

According to another aspect of the present invention there is provided a display layer to be attached to a vehicle as described above

Wherein, in use, the display layer is secured to the affixing means and at least the central axis of the display layer is under a higher tension than the edges of the display layer.

The term ‘support layer’ in accordance with the present invention should be understood to mean a sufficiently high strength or reinforced material that may be used as a siding on a vehicle such as a truck trailer or light truck although these are listed by way of example only.

It should be appreciated that the support layer could also include a sufficiently high strength or reinforced material used to provide an advertising medium on the side of buildings, across roads, between trees or the like, however these are listed by way of example and should not be seen to be limiting.

In preferred embodiments, the support layer may also be referred to as the soft curtain sidings of a truck trailer. These sidings are usually a heavy weight canvas or PVC with reinforced webbing or the like and are known to someone skilled in the art. The majority of truck curtain sidings are approximately 900 gsm weight, but can vary from 800 to 100 gsm, or even higher should the need arise.

Soft sidings are used on truck trailers in order to allow access to the inside of the trailer from the side of the trailer. The soft siding can be pulled back like a curtain as it may be attached to a rail on the top side of the trailer and secured at either end of the truck by affixing means.

It should therefore be appreciated that a display surface attached to a support layer as detailed above may be used as a soft siding and therefore both the display layer and the support layer move together as a combined soft siding, although this should not be seen to be limiting, as the combination could also be used to display various images on sides of buildings, between trees, across roads, or in various places where large advertising is desired.

It should be appreciated that the curtain may be connected to a rail either on the top side of the vehicle, or on both top and bottom. This connection allows the curtain to slide from either the left or the right side. The curtain can further be secured to the bottom side of the truck with ratchets or ties or the like and the curtain can be pulled back to any desired position, meaning not all such attachment devices need to be undone to access a load. Entry can be from either end of the curtain and this type of truck siding is known to one skilled in the art.

The term ‘affixing means’ in accordance with the present invention should be understood to mean a support beam, pole, extrusion or hard edge that may be positioned, usually, to the left and right of the curtain, although it should be appreciated that in some cases, it may be attached to the top and bottom if the direction of movement of the curtain is perpendicular to standard movement. This affixing means may be secured to the curtain and when pulled to meet, for example, the rear support frame of a truck trailer, a tension is applied to the curtain. Ratchets or the like are used to allow a user to apply tension to the curtain, and the affixing means may then be secured in place, therefore placing the curtain in a tensioned state.

In some embodiments the affixing means may be a solid beam configured to receive straps in either various or preset positions. Those straps may be connected at multiple points to the contoured sides of the display layer of each curtain, looped around the solid beam and ratcheted to such a tightness to provide the required tension to the display layer, although this scenario is listed by way of example and should not be seen to be limiting in any way.

In preferred embodiments the affixing means may be an extrusion configured to receive the edge the display layer and hold it securely. Furthermore, the extrusion may also be configured to receive the support layer either via a second connecting portion of the extrusion, or via other connecting means such as dome buttons, ratchet systems or other attaching means well known to those skilled in the art.

In some embodiments, the edge of at least one portion of the curtain may be shaped to provide an anchor element or the like that can be secured into the extrusion.

In preferred embodiments however, the support layer may be secured to the extrusion by various standard attachment methods, and the display layer may be configured to include an edge that may form an anchor element when secured into appropriately configured portion the extrusion.

In further preferred embodiments, a rope of desired proportions may be sewn into the edge of at the display layer of the curtain, where the display layer has been shaped into a sleeve shaped to receive the width of the rope. This rope and display layer combination may then be fed down one end of the extrusion and pulled into position so that the display layer is securely held along the edge where the rope is positioned. The extrusion may be configured to include a sleeve with the gap running the length of the sleeve so that the display layer may extend out from such. The thickness of the rope acts as the anchor element and ensures the curtain may be firmly attached to the extrusion, even under significant pressure.

An advantage of using a rope sewn into at least the display layer of the curtain is that the display layer can be slid out of the extrusion at any time and changed for another display layer.

It should further be appreciated that the extrusion may also be configured to receive end caps that provide a seal or stopper to reduce any slide of the rope and display layer down the extrusion when tension is removed.

The term ‘inwardly contoured’ in accordance with the present invention should be understood to refer to a portion of at least an edge of the display layer of the curtain that may be removed. This inward contouring can be either an even arched portion, an uneven scalloping, or any preferred shape in order to provide the tension points as desired on the display layer of the curtain itself.

In preferred embodiments of a pair of opposing edges may be inwardly contoured to maximise the tension provided across the display layer, however, it should be appreciated that any number of sides could be contoured, and therefore this example should not be seen to be limiting in any way.

In preferred embodiments, the contoured portions to be removed may be to the left and right of the curtain, where they are attached to the affixing means by the rope and sheath arrangement as described above.

It should however be appreciated that if the curtain or display layer were being used in a situation other than a truck siding, the portions to be removed may come from the top and bottom sides. This would be particularly applicable to display layers on the sides of buildings, although this is listed by way of example only and should not be seen to be limiting.

In preferred embodiments the contoured shape to be removed from the curtain or display layer may be an even arc shape proportionate to the amount of the curtain that is loose when placed on the side of a truck or the like without the contouring.

It should therefore be appreciated that the size of the contour to be removed may vary depending on the flexibility or give of the material, and that contour could be increased in size over time due to stretch over time of the material used. It should also be appreciated that the greater the desired tension of the material, the larger the contoured arc to be removed.

As discussed above, if multiple areas of tension are desired, then the contoured arc to be removed could consist of many scallop shapes, providing multiple tension lines across the display. This may be preferable depending on the image to be presented.

Due to the removal of a contoured arc from the display layer, it should be appreciated that any image prepared for presentation may be sufficiently shaped to compensate for the tension added to the fabric.

It is an advantage of the present invention that a lighter weight canvas or PVC may be used to present images on a truck siding or the like. The support layer provides the strength required to hold load within a truck or the like. The lighter display layer lends from the support layer but can itself be easily replaced therefore making it cheaper and easier to change the advertising picture on a truck siding, or on a building or the like. This is a distinct advantage over the prior art as not only is it cheaper to produce these lighter display layers, they also require less ink to print to a desired quality, but do not need to last as long due to the usually shorter length of the majority of advertising campaigns.

Additionally, the support layer may be either have a blank surface, or could be an old campaign picture itself, the image degraded beyond usefulness or out of date.

According to another aspect of the present invention there is provided a display surface adapted to be attached to a vehicle

characterised in that

the display layer is shaped with at least one least side inwardly contoured.

It should be appreciated that the display layer could be prepared according to any preset size and the rope edging or the like not permanently affixed until it is ready for use and the vehicle measured. In this way, it may be possible to prefabricate a number of curtains and then fit such to vehicles as they come available, provided the image to be shown is available to be cropped at certain points.

According to another aspect of the present invention there is provided a method of manufacture of a display layer adapted to be attached to a vehicle wherein the display layer is adapted to be secured to a support layer via at least one affixing means

the method characterised by the step of

a) inwardly contouring at least one side of the display layer.

As discussed previously, in order to manufacture a display layer with the correct amount of inward contouring of at least one side, the flexibility of the material must first be determined. Accordingly, once the flexibility can be determined, the shape of the initially printed image can be determined, so that the final tensioned image may be of the correct desired proportions.

According to another aspect of the present invention there is provided a method of preparing a display layer for attaching to a vehicle wherein the display layer is adapted to be secured by at least affixing means

characterised by the steps of

a) removing at least one contoured portion from the display layer material

b) adapting at least one edge of the display layer to form an anchor element.

According to another aspect of the present invention there is provided an attachment means for securing at least one display layer to a vehicle by at least one anchor element

wherein the attachment means is configured to receive at least one anchor element and allows the display layer to be secured under tension.

This invention has an advantage over present advertising on vehicle sidings and the like in that it is cheaper to produce, easy to replace and flexible enough to fit to variations in vehicle size to a point. Additionally, the tensioning of the display layer allows the truck and truck sidings to be used as normal, without any drawbacks due to the lighter fabric. Goods are still secured within the vehicle and the curtain system functions as normal.

### BRIEF DESCRIPTION OF DRAWINGS

Further aspects of the present invention will become apparent from the following description which is given by way of example only and with reference to the accompanying drawings in which:

FIG. 1 is a diagrammatic representation of a truck with curtain siding with advertising;

FIG. 2 is a diagrammatic representation of a truck with curtain siding with advertising in a retracted position;

FIG. 3 is a diagrammatic representation of the difference in shape between support layer and the display layer;

FIG. 4a is a diagrammatic representation of the preferred embodiment for attaching the display layer to an extrusion

FIG. 4b is a diagrammatic representation of the preferred embodiment of an extrusion

FIG. 4c is a diagrammatic representation of the end view of an extrusion with display layer attached; and

FIG. 5 is a diagrammatic representation of the display layer illustrating the regions of various level of tension.

### BEST MODES FOR CARRYING OUT THE INVENTION

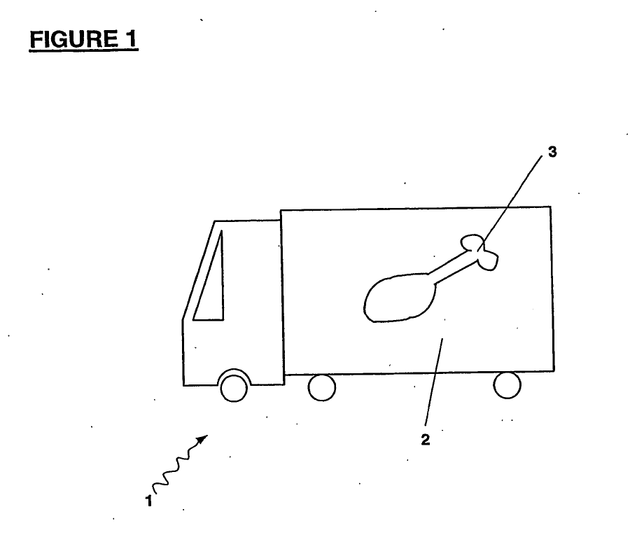

With reference to FIG. 1 there is illustrated a preferred embodiment of the present invention, being a truck, generally indicated by arrow 1, with curtain sidings (2) and advertising (3).

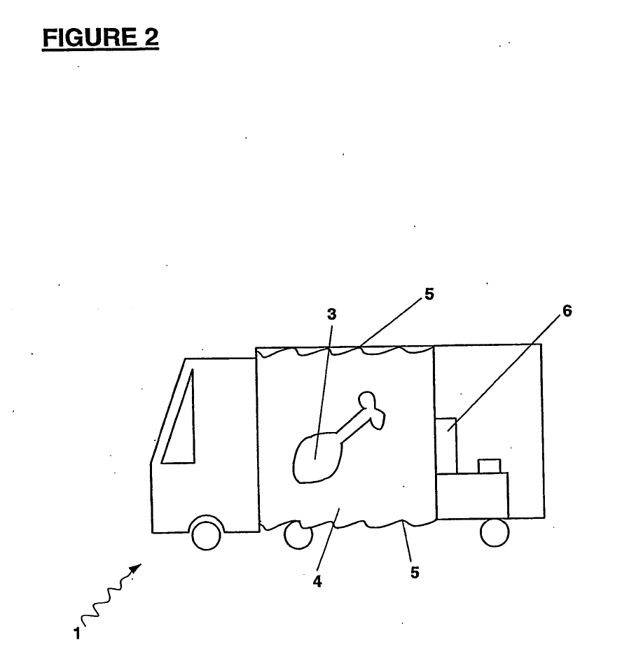

With reference to FIG. 2 there is illustrated a truck (1) with curtain siding showing advertising (3) in the retracted position (4).

The curtain (4) is attached at multiple points (5) along the top and bottom of the truck trailer and the goods (6) on the inside of the truck are shown.

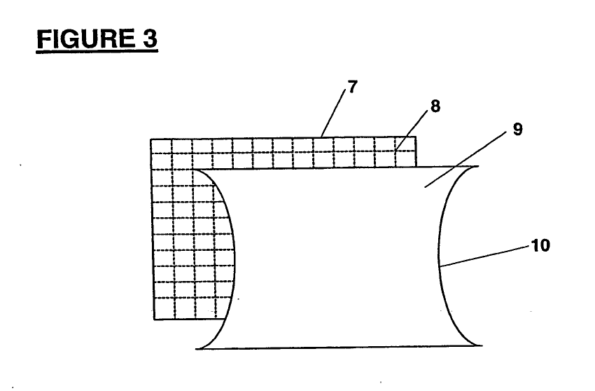

With reference to FIG. 3 there is illustrated the support layer (7) with reinforcing (8).

This reinforcing (8) can be in the form of a weighted webbing or the like to provide strength.

The display layer (9) has inward contouring (10) on opposing sides.

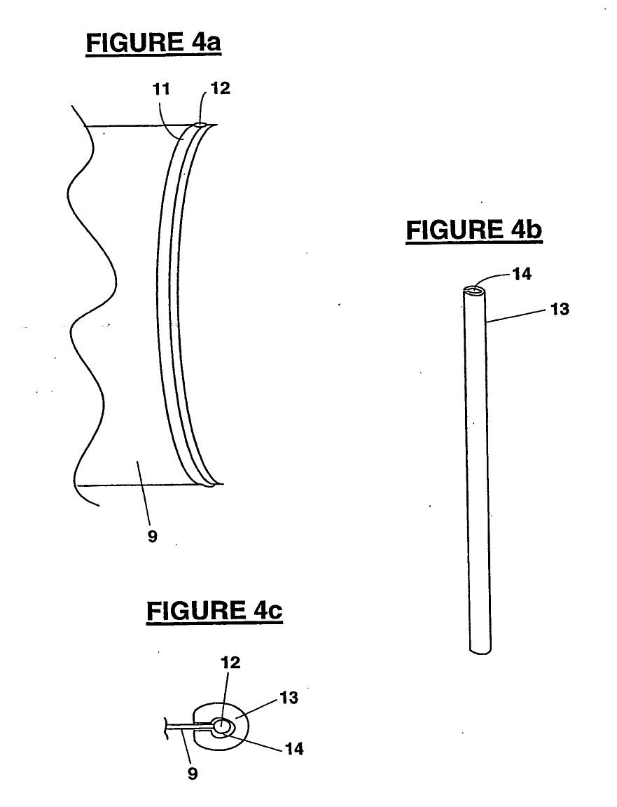

With reference to FIG. 4a there is illustrated a close up of the edge of the display layer (9) showing a sheath (11) with rope (12) inside.

It should be appreciated that this rope (12) will extend beyond the end of the sheath (11) so that it can be used to pull the display layer (9) down the length of the extrusion (13) shown in FIG. 4b.

With respect to FIG. 4b there is shown an extrusion (13) with internal recess (14) shaped to receive the rope (12) and sheath (11) configuration and hold it in place.

FIG. 4c shows a top side view of the extrusion (13) with shaped internal recess (14) with display layer (9) and rope (12) and sheath (11) inside.

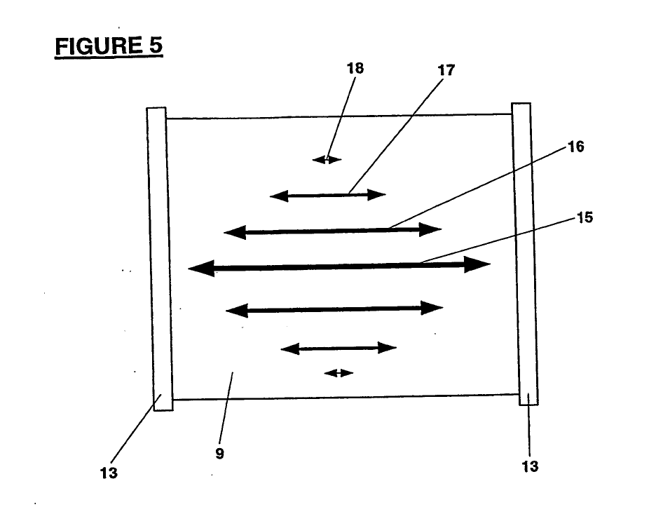

With respect to FIG. 5 there is illustrated the display layer (9) in its tensioned position.

The tension is maintained by the securing of the display layer (9) to the extrusion (13). Large arrow (15) indicates the region of highest tension by both the thickness of the arrow and then length of it.

Tension is reduced further away from the central axis, as indicated by arrows (16), (17) and (18) due to the reduced amount of material removed by the inward contouring.

Vehicles such as trucks (1) often make use of canvas curtains (2) to allow side access to load (6). These curtains (2) are affixed (5) to the top and bottom of each truck siding on a rail and can therefore be retracted (4).

Truck curtain sides (2) are also available to present advertising (3) as they are made from flexible fabric.

Unfortunately, each curtain (2) needs to be reinforced (8) to withstand the elements such as high wind and the movement of load (6) within the truck (1). These reinforced curtains (7) are therefore costly to print, being thicker material, more expensive to replace.

A thinner display layer (9) can therefore be overlaid above the curtain (2). In order to hold the display layer (9) taut across the reinforced curtain (7), it needs to be tensioned.

In order to apply tension (15) to the display layer (9), an inward contour (10) is removed from opposing sides of the display layer equal to the amount that would be loose once the display layer (9) is in position.

In order to secure the display layer (9) in its tensioned position (15), the opposing sides of the display layer must be firmly attached to a frame (13) or siding.

In order to provide a means to attach the display layer (9) to the frame (13) or siding, a sheath (11) is created by overlapping the end of the display layer (9) to create the tube or sheath (11).

A rope (12) of a predetermined thickness can then be positioned within the sheath (11) (either at the time of creation of the sheath) or by threading it in later. The sheath (11) then contains the rope (12) and is thicker in diameter than the display layer (9).

This rope/sheath (11,12) combination is then be slid into a frame (13) or siding which has been formed as an extrusion with an internal recess (14) just larger than the thickness of the rope (12).

Once the frame (13) or siding containing the display layer (9) is affixed to the frame of the truck (not shown), the display layer (9) is stretched or placed under tension (15-18) and the region of greatest contouring (15) is held at the greatest tension.

This tensioning (15-18) ensures that the centre of the display layer will remain substantially flat against support structure (7) and not flap.

As the display layer (9) is of a thinner material without reinforcing (8), the cost to produce and print them is greatly reduced. Additionally, the sheath (11) can be sewn in on site, so the final fitting of the display layer to a particular vehicle is therefore more flexible.

Aspects of the present invention have been described by way of example only and it should be appreciated that modifications and additions may be made thereto without departing from the scope thereof.

1-28. (canceled)

29. A display layer adapted to be attached to a vehicle wherein the display layer is formed from at least one sheet of flexible material securable in use to a support layer via at least one affixing means, thereby tensioning the display layer into a planar sheet under a greater tension along a non-peripheral axis in the plane of the sheet compared to tension along any peripheral axis, said tensioning being provided by stretching the display layer to secure to said affixing means, characterised in that said greater tension is provided by stretching the display layer over a greater distance along said non-peripheral axis than said peripheral axis.

30. A display layer as claimed in claim 29, wherein prior to stretching, adjacent mating portions of the affixing means and the display layer are non-coterminous with a greater mutual separation along said non-peripheral axis.

31. A display layer as claimed in claim 29, wherein said non-peripheral axis is substantially perpendicular to said affixing means.

32. A display layer as claimed in claim 29, wherein a pair of affixing means are located on opposing sides of the display layer.

33. A display layer as claimed in claim 29, wherein at least one of either adjacent mating portions of the affixing means and the display layer are inwardly contoured in the plane of the tensioned sheet away from the other mating portion.

34. A display layer as claimed in claim 29, wherein the display layer is able to receive ink.

35. A display layer as claimed in claim 29, wherein the display layer includes at least one canvas portion.

36. A display layer as claimed in claim 29, wherein the display layer includes at least one PVC portion

37. A display layer as claimed in claim 29, wherein the display layer includes a protective coating.

38. A display layer as claimed in claim 29, wherein at least one edge of the display layer is adapted to provide an anchor element when secured to the affixing means.

39. A display layer as claimed in claim 38, wherein the anchor element includes a sleeve and at least one rope.

40. A display layer as claimed in claim 39, wherein the support layer includes reinforcing.

41. A display layer as claimed in claim 29, wherein the support layer forms a moveable curtain.

42. A display layer as claimed in claim 29, wherein the display layer is moveable with the support layer.

43. A display layer as claimed in claim 29, wherein the affixing means includes at least one beam adapted to be connected to the support layer.

44. A display layer as claimed in claim 29, wherein the affixing means includes at least one extrusion.

45. A display layer as claimed in claim 44, wherein the extrusion is configured to receive an anchor element.

46. A display layer as claimed in claim 29, wherein the affixing means is configured to secure both the display layer and the support layer.

47. A method of manufacture of a display layer as claimed in claim 29, characterised by the step of
a) inwardly contouring at least one side of the display layer.

48. A method of preparing a display layer as claimed in claim 29 for attachment to a vehicle wherein the display layer is adapted to be secured by at least one affixing means characterised by the steps of
a) forming at least one contoured portion in a peripheral portion of the display layer material; and
b) adapting at least one edge of the display layer material to form an anchor.

49. An attachment means for securing at least one display layer as claimed in claim 29 to a vehicle by at least one anchor element wherein the attachment means is configured to receive at least one anchor element and allows the display layer to be secured under tension.
